(19) United States
(12) Patent Application Publication
(10) Pub. No.: US 2012/0104874 A1
(43) Pub. Date: May 3, 2012

(54) VIBRATING-TYPE ELECTROMAGNETIC GENERATOR

(76) Inventors: Yeong-Maw HWANG, Haohsiung City (TW); Wen-Long Lu, Haohsiung City (TW)

(21) Appl. No.: 12/985,465

(22) Filed: Jan. 6, 2011

(30) Foreign Application Priority Data
Oct. 28, 2010 (TW) 099136915

(51) Int. Cl. H02K 35/04

(52) U.S. Cl. 310/25

(57) ABSTRACT

A vibrating-type electromagnetic generator includes a substrate, a metal wire, and a magnetic member. The substrate includes a vibrating arm member and an opening disposed on the vibrating arm member; the metal wire is configured on the substrate and is passed around the opening, and has a first electrode end and a second electrode end; and the magnetic member is configured in the opening, in which when the vibrating arm member receives an external force, the metal wire induces an electric energy with the magnetic member through vibration of the vibrating arm member, and outputs the electric energy through the first electrode end and the second electrode end.

### CROSS-REFERENCE TO RELATED APPLICATION

This application claims the benefit of Taiwan Patent Application No. 099136915, filed on Oct. 28, 2010, which is hereby incorporated by reference for all purposes as if fully set forth herein.

### BACKGROUND OF THE INVENTION

1. Field of Invention

The present invention relates to a generator, and more particularly to a vibrating-type electromagnetic generator.

2. Related Art

With diversification of functions of electronic products, the electric energy required by the electronic products is also correspondingly increased, such that various electric generators capable of supplying the electric energy are developed successively, in which one of electric generators is an electromagnetic electric generator. The electromagnetic electric generator can be manufactured through a semiconductor or a Micro-Electro-Mechanical Systems (MEMS) technology, thereby having a characteristic of miniaturization, and quite meeting demands of power supply of recent electronic products.

### SUMMARY OF THE INVENTION

The present invention is directed a vibrating-type electromagnetic generator.

According to the above objective, the present invention provides a vibrating-type electromagnetic generator, which includes a substrate, a metal wire, and a magnetic member. The substrate includes a vibrating arm member and an opening disposed on the vibrating arm member; the metal wire is configured on the substrate and is passed around the opening, and has a first electrode end and a second electrode end; and the magnetic member is configured in the opening, in which when the vibrating arm member receives an external force, the metal wire induces an electric energy with the magnetic member through vibration of the vibrating arm member, and outputs the electric energy through the first electrode end and the second electrode end.

According to the above objective, the present invention further provides a vibrating-type electromagnetic generator, which includes a first substrate, a second substrate, a first metal wire, a second metal wire, and a magnetic member. The first substrate includes a first vibrating arm member and a first opening disposed on the first vibrating arm member; the second substrate is disposed on the first substrate, and includes a second vibrating arm member and a second opening disposed on the second vibrating arm member; the first metal wire is configured on the first substrate and is passed around the first opening, and has a first electrode end and a second electrode end; the second metal wire is configured on the second substrate and is passed around the second opening, and has a third electrode end and a fourth electrode end, in which the third electrode end is electrically connected to the second electrode end; and the magnetic member is configured in the first opening and the second opening, in which when a combination of the first and second vibrating arm members receives an external force, the first and second metal wires induce an electric energy with the magnetic member through vibration of the first and second vibrating arm members, and outputs the electric energy through the first electrode end and the fourth electrode end.

According to the present invention, the metal wire is configured on the substrate and is passed around the opening, such that when the vibrating arm member receives the external force, the metal wire induces the electric energy with the magnetic member through the vibration of the vibrating arm member and outputs the electric energy through the electrode ends. Furthermore, the substrate may be disposed to have a multi-layer configuration, and the magnetic member is configured in the opening of the vibrating arm member on the substrate of each layer, such that when the vibrating arm member on the substrate of each layer receives the external force, the metal wire on the substrate of each layer induces the electric energy with the magnetic member through the vibration of the vibrating arm member, in which an induced voltage is a sum of voltages output from each layer. Finally, the electric energy is output through the electrode ends.

### BRIEF DESCRIPTION OF THE DRAWINGS

The present invention will become more fully understood from the detailed description given herein below for illustration only, and thus are not limitative of the present invention, and wherein:

FIG. 1A is an exploded view of a vibrating-type electromagnetic generator according 10 to an embodiment of the present invention;

FIG. 1B is a combined view of a magnetic member as shown in FIG. 1A configured in an opening;

FIG. 1C is a schematic view in which the vibrating-type electromagnetic generator as shown in FIG. 1B supplies an electric energy to a load;

FIG. 2A is a three-dimensional view of a vibrating-type electromagnetic generator according to another embodiment of the present invention;

FIG. 2B is a schematic view in which the vibrating-type electromagnetic generator as shown in FIG. 2A supplies an electric energy to a load;

FIG. 3A is an exploded view of a vibrating-type electromagnetic generator according to another embodiment of the present invention;

FIG. 3B is a schematic view in which the vibrating-type electromagnetic generator as shown in FIG. 3A supplies an electric energy to a load; and

FIG. 4 is a three-dimensional view of a vibrating-type electromagnetic generator according to another embodiment of the present invention.

### DETAILED DESCRIPTION OF THE INVENTION

To make the above objectives, features, and characteristics of the present invention more comprehensible, embodiments of the present invention are described in detail with reference to the accompanying drawings.

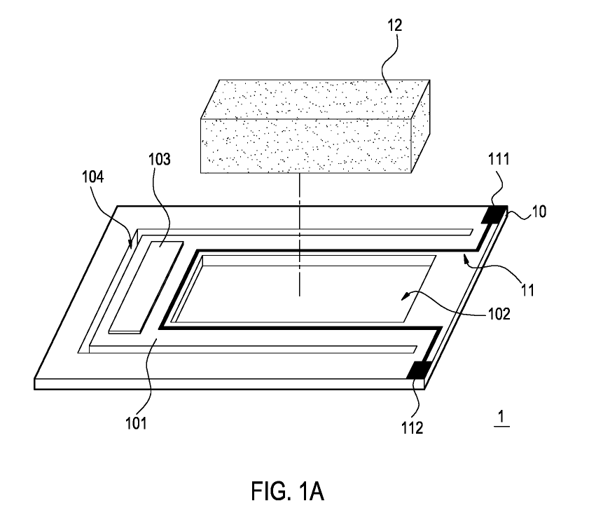

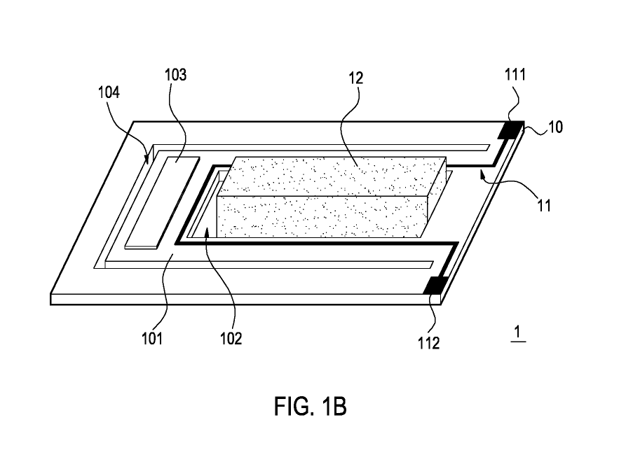

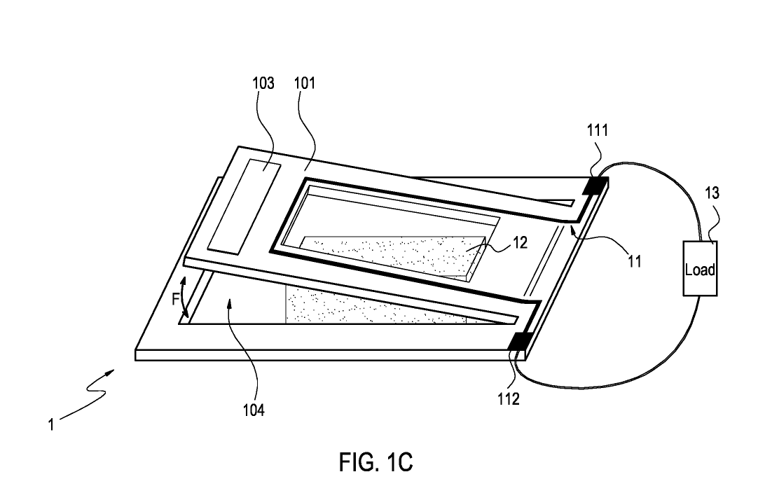

FIG. 1A is an exploded view of a vibrating-type electromagnetic generator according to an embodiment of the present invention; and FIG. 1B is a combined view of a magnetic member as shown in FIG. 1A configured in an opening. As shown in FIG. 1A and FIG. 1B, the vibrating-type electromagnetic generator 1 includes a substrate 10, a metal wire 11, and a magnetic member 12.

The substrate 10 includes a vibrating arm member 101 and an opening 102 disposed on the vibrating arm member 101. The vibrating arm member 101 is flexible, and is further configured with a weight unit 103, so as to increase a vibration weight of the vibrating arm member 101 when receiving an external force. A weight of the weight unit 103 may be designed depending on practical vibration demands of the vibrating arm member 101 (for example, a vibration frequency of the vibrating arm member 101). In addition, the substrate 10 further includes a space 104, for allowing the vibrating arm member 101 to vibrate when receiving the external force.

The metal wire 11 is configured on the substrate 10 and is passed around the opening 102. The metal wire 11 has a first electrode end 111 and a second electrode end 112, and may be considered as a metal coil of the vibrating-type electromagnetic generator 1. A material of the metal wire 11 may be implemented by metal, for example, copper, gold, or silver, but the present invention is not limited thereto.

The magnetic member 12 is configured in the opening 102 and is located in the substrate 10, and the magnetic member 12 may be implemented by a magnet in practical applications.

The vibrating-type electromagnetic generator 1 may be manufactured through, for example, sintering processing technology, laser processing technology, MEMS processing technology, Multi-layer Ceramic Capacitor (MLCC) process, semiconductor Integrated Circuit (IC) process, Low Temperature Co-fired Ceramic (LTCC) processing technology, or Flexible Printed Circuit (FPC) process, so as to meet a demand of miniaturization, such that the vibrating-type electromagnetic generator 1 can be applied to various precise electronic products.

FIG. 1C is a schematic view in which the vibrating-type electromagnetic generator as shown in FIG. 1B supplies an electric energy to a load.

As shown in FIG. 1C, the first electrode end 111 and the second electrode end 112 of the metal wire 11 can be electrically connected to a load 13, such that when a user intends to use the vibrating-type electromagnetic generator 1 to generate an electric energy to the load 13, the user may apply an external force to the vibrating-type electromagnetic generator 1. Upon receiving the external force F, the vibrating arm member 101 vibrates in the space 104, and the vibration weight of the vibrating arm member 101 is increased due to the weight of the weight unit 103. The metal wire 11 induces an electric energy with the magnetic member 12 (that is, the electric energy is generated by a principle of relative motion between the metal wire 11 and the magnetic member 12) through the vibration of the vibrating arm member 101 (as shown in FIG. 1C, an up-and-down vibration direction is indicated by an arrow), and then the metal wire 11 outputs the electric energy to the load 13 through the first electrode end 111 and the second electrode end 112, for being used by the load 13.

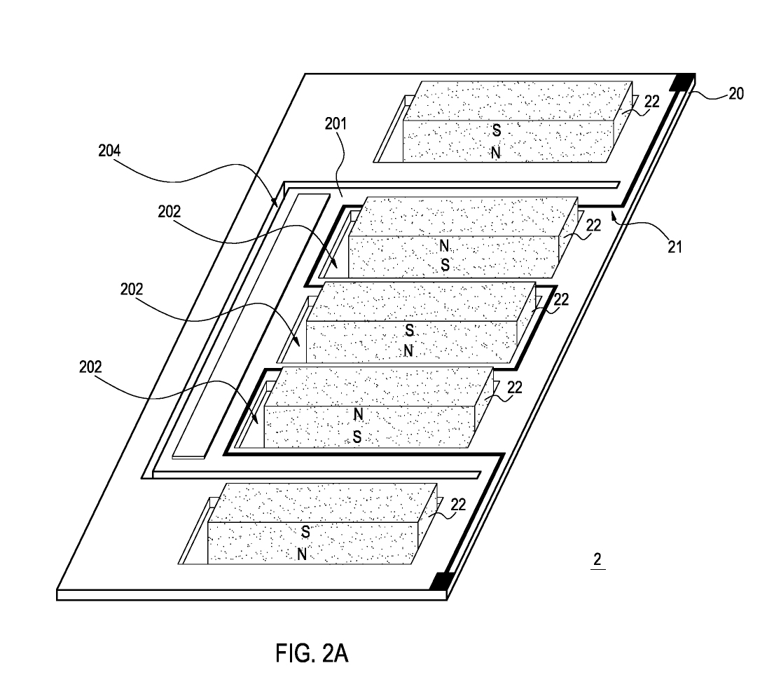

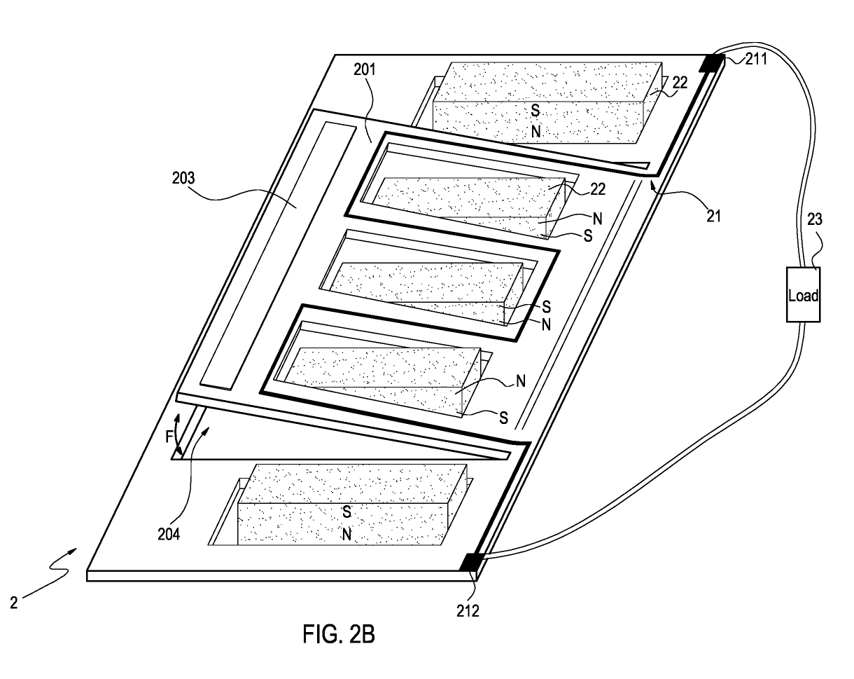

FIG. 2A is a three-dimensional view of a vibrating-type electromagnetic generator according to another embodiment of the present invention.

As shown in FIG. 2A, the vibrating-type electromagnetic generator 2 of this embodiment includes a substrate 20, a metal wire 21, and magnetic members 22. Differences from the above embodiment include the following. A plurality of openings 202 are disposed in a vibrating arm member 201 of the vibrating-type electromagnetic generator 2 of this embodiment, and the magnetic members 22 are disposed in the substrate 20 and each opening 202, such that the plurality of magnetic members 22 may be used to increase strength of an induced magnetic field of the vibrating-type electromagnetic generator 2, so as to improve strength of an electric energy induced by the metal wire 21. Each of the magnetic members 22 is implemented by a magnet having opposite magnetic poles (S pole and N pole), and is arranged in the opening 202 in sequence with a corresponding magnetic pole relation of SN and NS or NS and SN. In addition, the substrate 20 includes a space 204, for allowing the vibrating arm member 201 to vibrate when receiving the external force.

FIG. 2B is a schematic view in which the vibrating-type electromagnetic generator as shown in FIG. 2A supplies an electric energy to a load.

As shown in FIG. 2B, a first electrode end 211 and a second electrode end 212 of the metal wire 21 may be electrically connected to a load 23, such that when a user intends to use the vibrating-type electromagnetic generator 2 to generate an electric energy to the load 23, the user may apply an external force to the vibrating-type electromagnetic generator 2. Upon receiving the external force F, the vibrating arm member 201 vibrates in the space 204, and a vibration weight of the vibrating arm member 201 is increased due to weight of a weight unit 203. The metal wire 21 induces an electric energy with the magnetic members 22 (that is, the electric energy is generated by a principle of relative motion between the metal wire 21 and the magnetic members 22) through the vibration of the vibrating arm member 201 (as shown in FIG. 2B, an up-and-down vibration direction is indicated by an arrow), and then the metal wire 21 outputs the electric energy to the load 23 through the first electrode end 211 and the second electrode end 212, for being used by the load 23.

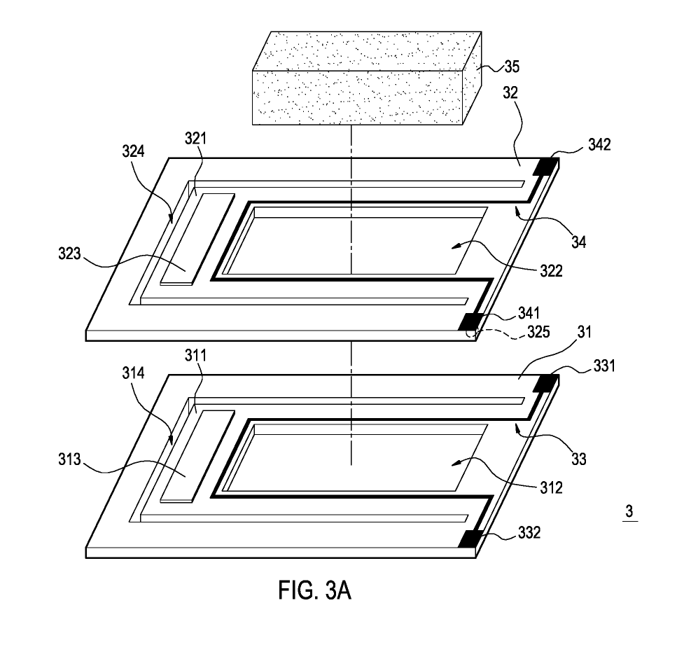

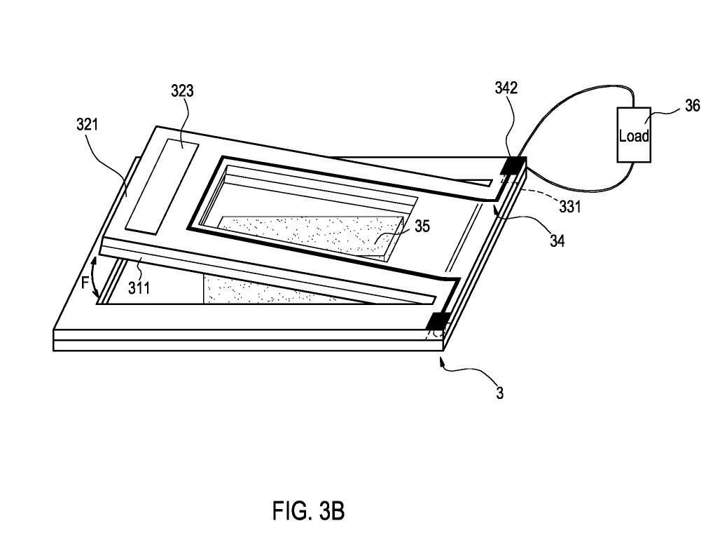

FIG. 3A is an exploded view of a vibrating-type electromagnetic generator according to another embodiment of the present invention. As shown in FIG. 3A, the vibrating-type electromagnetic generator 3 includes a first substrate 31, a second substrate 32, a first metal wire 33, a second metal wire 34, and a magnetic member 35.

The first substrate 31 includes a first vibrating arm member 311 and a first opening 312 disposed on the first vibrating arm member 311. The first vibrating arm member 311 is flexible, and is further configured with a first weight unit 313, so as to increase a vibration weight of the first vibrating arm member 311 when receiving an external force. A weight of the first weight unit 313 may be designed depending on practical vibration demands of the first vibrating arm member 311 (for example, a vibration frequency of the first vibrating arm member 311). In addition, the substrate 31 further includes a first space 314, for allowing the first vibrating arm member 311 to vibrate when receiving the external force.

The second substrate 32 is disposed right above the first substrate 31. The second substrate 32 includes a second vibrating arm member 321 and a second opening 322 disposed on the second vibrating arm member 321. The second vibrating arm member 321 is flexible, and is further configured with a second weight unit 323, so as to increase a vibration weight of the second vibrating arm member 321 when receiving an external force. A weight of the second weight unit 323 may be designed depending on practical vibration demands of the second vibrating arm member 321 (for example, a vibration frequency of the second vibrating arm member 321). In addition, the second substrate 32 further includes a second space 324, for allowing the second vibrating arm member 321 to vibrate when receiving the external force; in addition, the second substrate 32 further includes a conductive through hole 325.

The first metal wire 33 is configured on the first substrate 31 and is passed around the first opening 312. The first metal wire 33 has a first electrode end 331 and a second electrode end 332, and is considered as a metal coil of the vibrating-type electromagnetic generator 3. A material of the first metal wire 33 may be implemented by metal, for example, copper, gold, or silver, but the present invention is not limited thereto.

The second metal wire 34 is configured on the second substrate 32 and is passed around the second opening 322. The second metal wire 34 has a third electrode end 341 and a fourth electrode end 342, and is also considered as metal coil of the vibrating-type electromagnetic generator 3. The third electrode end 341 is electrically connected to the second electrode end 332, for example, the third electrode end 341 is electrically connected to the second electrode end 332 through the conductive through hole 325. In addition, a material of the second metal wire 34 may be implemented by metal, for example, copper, gold, or silver, but the present invention is not limited thereto.

The magnetic member 35 is configured in the corresponding first opening 312 and second opening 322, and may be implemented by a magnet in practical applications.

A combination of the first vibrating arm member 311 and the second vibrating arm member 321 synchronously vibrates while receiving an external force, such that the first substrate 31 is combined with the second substrate 32 after configuration of each layer.

The above vibrating-type electromagnetic generator 3 may be manufactured through, for example, sintering processing technology, laser processing technology, MEMS processing technology, MLCC process, semiconductor IC process, LTCC processing technology, or FPC process, so as to meet a demand of miniaturization, such that the vibrating-type electromagnetic generator 3 can be applied to various precise electronic products.

FIG. 3B is a schematic view in which the vibrating-type electromagnetic generator as shown in FIG. 3A supplies an electric energy to a load. As shown in FIG. 3A and FIG. 3B, the first electrode end 331 and the fourth electrode end 342 are electrically connected to a load 36, such that when a user intends to use the vibrating-type electromagnetic generator 3 to generate an electric energy to the load 36, the user applies an external force to the vibrating-type electromagnetic generator 3. Upon receiving the external force F, the combination of the first vibrating arm member 311 and the second vibrating arm member 321 vibrates in the first space 314 or the second space 324, and a vibration weight of the combination of the first vibrating arm member 311 and the second vibrating arm member 321 is increased respectively due to the weights of the first weight unit 313 and the second weight unit 323. The first metal wire 33 and the second metal wire 34 induce an electric energy with the magnetic member 35 through the vibration of the combination of the first vibrating arm member 311 and the second vibrating arm member 321 (as shown in FIG. 3B, an up-and-down vibration direction is indicated by an arrow), and output the electric energy to the load 36 through the first electrode end 331 and the fourth electrode end 342, for being used by the load 36.

It can be known that through the multi-layer substrate structure, a circuit density of an induction conductor of the vibrating-type electromagnetic generator 3 can be increased, so as to improve an overall electric generation efficiency of the vibrating-type electromagnetic generator 3, that is, the vibrating-type electromagnetic generator 3 can supply the higher electric energy for being used by the load 36.

It should be noted that the multi-layer substrate structure is not limited to the above first substrate 31 and second substrate 32, and more than two substrates are also applicable, so as to improve the overall electric generation efficiency of the vibrating-type electromagnetic generator 3.

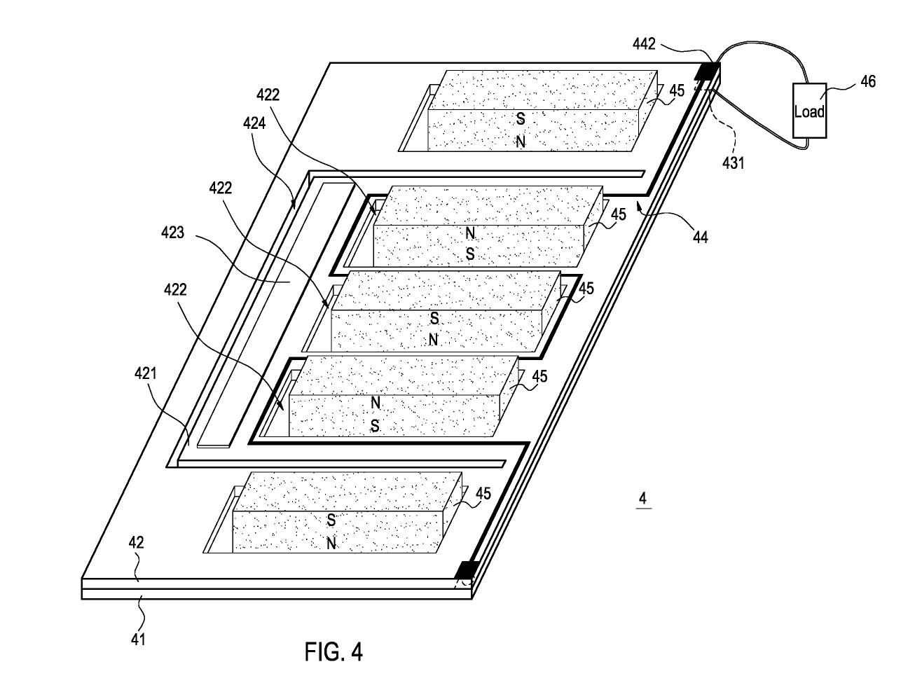

FIG. 4 is a three-dimensional view of a vibrating-type electromagnetic generator according to another embodiment of the present invention. As shown in FIG. 4, the vibrating-type electromagnetic generator 4 of this embodiment includes a first substrate 41, a second substrate 42, a first metal wire, a second metal wire 44, and magnetic members 45. Differences from the above embodiment include the following. A plurality of corresponding first openings and a plurality of corresponding second openings 422 are respectively disposed on a combination of a first vibrating arm member and a second vibrating arm member 421 of the vibrating-type electromagnetic generator 4 of this embodiment, and the magnetic members 45 are disposed in the first substrate 41, the second substrate 42, each of first openings, and each of the second openings 422. Therefore, the plurality of magnetic members 45 are used to increase strength of an induced magnetic field of the vibrating-type electromagnetic generator 4, so as to improve strength of an electric energy induced by the first metal wire and the second metal wire 44. Each of the magnetic members 45 is implemented by a magnet having opposite magnetic poles (S pole and N pole), and arranged in each of the corresponding first openings and second openings 422 in sequence with a corresponding magnetic pole relation of SN and NS or NS and SN. For sake of conciseness, the first metal wire and the first vibrating arm member of the first substrate 41 are not shown in FIG. 4 because of the visual angle, and the reference may be made to the first substrate in FIG. 3A.

A first electrode end 431 and a fourth electrode end 442 may be electrically connected to a load 46, such that when a user intends to use the vibrating-type electromagnetic generator 4 to generate an electric energy to the load 46, the user applies an external force to the vibrating-type electromagnetic generator 4. Upon receiving the external force F, the combination of the first vibrating arm member and the second vibrating arm member 421 vibrates in the first space or the second space 424, and a vibration weight of the combination of the first vibrating arm member and the second vibrating arm member 421 is increased respectively due to weights of a first weight unit and a second weight unit 423. The first metal wire and the second metal wire 44 induce an electric energy with the magnetic members 45 through the vibration of the combination of the first vibrating arm member and the second vibrating arm member 421, and then output the electric energy to the load 46 through the first electrode end 431 and the fourth electrode end 442, for being used by the load 46.

It can be known that in the vibrating-type electromagnetic generator 4, multiple layers of substrates improve an overall electric generation efficiency, and the plurality of magnetic members 45 further increases the strength of the induced magnetic field of the vibrating-type electromagnetic generator 4, so as to improve the strength of the electric energy induced by the first metal wire and the second metal wire 44, thereby improving an output electric power and an electric power density of the vibrating-type electromagnetic generator 4.

As described above, the vibrating-type electromagnetic generator according to the present invention has the following features.

1. The metal wire is configured on the substrate and is passed around the opening, such that when the vibrating arm member receives the external force, the metal wire induces the electric energy with the magnetic member through the vibration of the vibrating arm member, and outputs the electric energy through the electrode ends for being used by the load.

2. The substrate may be disposed to have the multi-layer configuration, and the magnetic member is configured in the opening of the vibrating arm member on the substrate of each layer, such that when the vibrating arm member on the substrate of each layer receives the external force, the metal wire on the substrate of each layer induces the electric energy with the magnetic member through the vibration of the vibrating arm member, in which the induced voltage is the sum of the voltages output from each layer, and outputs the electric energy through the electrode ends for being used by the load.

3. In the vibrating-type electromagnetic generator, multiple layers of substrates improve the overall electric generation efficiency, and the plurality of magnetic members further increase the strength of the induced magnetic field of the vibrating-type electromagnetic generator, so as to improve the strength of the electric energy induced by the metal wire of the substrate of each layer, thereby improving the output electric power and the electric power density of the vibrating-type electromagnetic generator.

4. The vibrating-type electromagnetic generator may be manufactured through, for example, the sintering processing technology, the laser processing technology, the MEMS processing technology, the MLCC process, the semiconductor IC process, the LTCC processing technology, or the FPC process, so as to meet the demand of miniaturization, such that the vibrating-type electromagnetic generator can be applied to various precise electronic products.

To sum up, although the preferred embodiments of the present invention are described in detail above, they are not intended to limit the scope of the present invention. Any equivalent variations or modifications made without departing from the spirit of the present invention shall fall within the scope of the present invention.

What is claimed is:

1. A vibrating-type electromagnetic generator, comprising:
a substrate, comprising a vibrating arm member and an opening disposed on the vibrating arm member;
a metal wire, configured on the substrate and passed around the opening, and having a first electrode end and a second electrode end; and
a magnetic member, configured in the opening;
wherein when the vibrating arm member receives an external force, the metal wire induces an electric energy with the magnetic member through vibration of the vibrating arm member, and outputs the electric energy through the first electrode end and the second electrode end.

2. The vibrating-type electromagnetic generator according to claim 1, wherein the vibrating arm member is further configured with a weight unit.

3. The vibrating-type electromagnetic generator according to claim 1, wherein the vibrating arm member is flexible.

4. The vibrating-type electromagnetic generator according to claim 1, wherein the substrate further comprises a space, for allowing the vibrating arm member to vibrate when receiving the external force.

5. The vibrating-type electromagnetic generator according to claim 1, wherein the magnetic member is a magnet.

6. The vibrating-type electromagnetic generator according to claim 1, wherein the first electrode end and the second electrode end are further electrically connected to a load to output the electric energy to the load.

7. A vibrating-type electromagnetic generator, comprising:
a first substrate, comprising a first vibrating arm member and a first opening disposed on the first vibrating arm member;
a second substrate, disposed on the first substrate, and comprising a second vibrating arm member and a second opening disposed on the second vibrating arm member;
a first metal wire, configured on the first substrate and passed around the first opening, and having a first electrode end and a second electrode end;
a second metal wire, configured on the second substrate and passed around the second opening, and having a third electrode end and a fourth electrode end, wherein the third electrode end is electrically connected to the second electrode end; and
a magnetic member, configured in the first opening and the second opening;
wherein when a combination of the first and second vibrating arm members receives an external force, the first and second metal wires induce an electric energy with the magnetic member through vibration of the first and second vibrating arm members, and outputs the electric energy through the first electrode end and the fourth electrode end.

8. The vibrating-type electromagnetic generator according to claim 7, wherein the first and second vibrating arm members are further configured with a weight unit.

9. The vibrating-type electromagnetic generator according to claim 7, wherein the first and second vibrating arm members are flexible.

10. The vibrating-type electromagnetic generator according to claim 7, wherein the first and second substrates further comprise a space, for allowing the combination of the first and second vibrating arm members to vibrate when receiving the external force.

11. The vibrating-type electromagnetic generator according to claim 7, wherein the magnetic member is a magnet.

12. The vibrating-type electromagnetic generator according to claim 7, wherein the first electrode end and the fourth electrode end are further electrically connected to a load to output the electric energy to the load.

13. The vibrating-type electromagnetic generator according to claim 7, wherein the second substrate further comprises a conductive through hole, and the third electrode end is electrically connected to the second electrode end through the conductive through hole.
